(19) United States
(12) Patent Application Publication
(10) Pub. No.: US 2003/0071543 A1
(43) Pub. Date: Apr. 17, 2003

(54) Mail and package inspection device and method

(76) Inventor: Farhad Daghighian, Santa Monica, CA (US)

Correspondence Address: KOPPEL & JACOBS, Suite 107, 555 St. Charles Drive, Thousand Oaks, CA, 91360, US

(21) Appl. No.: 09/981,270

(22) Filed: Oct. 17, 2001

(51) Int. Cl. A61G 11/00

(52) U.S. Cl. 312/1

(57) ABSTRACT

A sealable container into which envelopes or packages can be placed for opening and inspection for contamination by biological or chemical agents. The container has a removeable lid that can be reattached and sealed to the container so that the contents of the container are safely enclosed therein. The container has gloves attached to one wall so that items placed in the container can be manipulated by a user. The container also includes detection means for visualizing or detecting the presence of a foreign substance that may be dispersed from the envelope or package once opened.

The present invention relates to an equipment for opening and inspecting packages for contamination by biological or chemical agents and methods for use of such equipment.

### BACKGROUND

Following the events of Sep. 11, 2001 there is considerable concern regarding terrorist activities which may be perpetrated on the public. Of particular concern is the contamination of normally used objects by chemical or biological agents. In particular, letters and packages have been found to be contaminated with a powdery substance believed to contain a form of anthrax.

Anthrax is caused by the bacterium Bacillus anthracis. It is a disease of sheep, cattle, horses, goats, and swine. The disease has a skin form (cutaneous anthrax) and a pulmonary form (inhalation anthrax). In the cutaneous form, the infection is transmitted through a break in the skin. In the pulmonary form, infection occurs by breathing in anthrax spores. The resultant pneumonia rapidly causes respiratory distress followed by death. Meningitis can also develop. Because the spores are long lasting and the incubation is short and disability is severe, anthrax has been considered as a significant biological weapon.

Therefore, there is a need for a means to easily examine and open normally received letters and packages in an environment which is safe (protects the user) and which, at the same time will allow suspicious items, and any substance contained therein, to be retained for inspection by proper health authorities, and which can, at the same time be readily transportable, with all of its contents to a safe, remote location, if suspicious substances are located.

Biological safety cabinets, usually referred to as laminar flow hoods and glove boxes, have been used in laboratories for many years for handling toxic substances. These safety cabinets are divided into three classes based upon the type of protection provided. Class I and II cabinets use an air curtain and Class III uses a physical barrier to protect the investigator. Class II and III cabinets filter the air before it is blown onto the work surface, and all three cabinets have filtered exhaust.

The Class I cabinet is the simplest form of biological safety cabinet and consists of an enclosure with a front view panel and a full-width work opening. Room air, drawn into the cabinet through the work opening and into the back wall baffle, prevents airborne contaminants inside the cabinet from escaping into the room, as in a fume hood. The exhaust is includes a HEPA-filter to catch any airborne particles. Optional modes of operation include a front closure panel with access ports, which can be placed over the work opening thus reducing the amount of open area and raising the face velocity. Another option is to attach arm-length gloves to the access ports of the closure panel. In this mode, the cabinet serves as a glove box but does not provide containment equivalent to a Class III system. Since the operator's hands and arms are not protected from contamination, control of contact contamination is dependent upon the use of gloves and other protective clothing. They provide personal protection during specific applications with low risk oncogenic viruses, bacteria, and recombinant DNA at Biosafety Level 2 (BL2) containment level, as well as for chemical carcinogens, and low-level radioactive materials and volatile solvents provided the: face velocity is adequate.

In the Class II cabinet, commonly known as a laminar flow or biosafety hood, room air is drawn into the grille at the front edge of the work surface, passed through a HEPA filter, and recirculated into the cabinet work space through the overhead grille and is exhausted after passing through a HEPA filter. An air barrier prevents airborne contaminants generated in the cabinet from escaping through the work opening. Class II cabinets are not absolute containment devices. Based on standard procedures for determining a protection factor for spore release from within the enclosure, acceptable protection is not usually achieved in routine use. Class II cabinets are suitable for most projects, are convenient to use, and offer adequate personnel and product protection if used properly with low to moderate-risk oncogenic viruses, CDC classes 1 to 3 etiologic agents, and recombinant DNA materials requiring BL 2 containment. However, since Class II cabinets may recirculate a large fraction of the air flowing through them, they are only suitable for work with dilute concentrations of radioactive materials, toxic chemicals or carcinogens of low volatility. They are not suitable for containment of highly toxic materials and, because of air flow, may actual result in distribution of powdered substances.

The Class III cabinet, commonly known as a glove box, is a hermetically sealed enclosure maintained under negative pressure for confining extremely hazardous research materials. It provides the highest level of personnel and environmental protection from vapor or aerosol exposure; and from splatter or contact contamination. Operations within the cabinet are conducted through attached gloves. Materials are introduced and removed through double-door pass-through port containing a dunk tank filled with liquid disinfectant or equipped with a sterilizer. Ventilation is provided by drawing air into the cabinet through a HEPA filter and exhausting it through two HEPA filters in series or one HEPA and an incinerator. Class III cabinets are suitable for all research procedures with high-risk oncogenic viruses, CDC class 4 etiologic agents, and recombinant DNA materials requiring up to BL4 level of physical containment. The cabinets may also be used for research with highly toxic chemicals and carcinogens provided the effluents are treated to meet emission regulations. Protection by the Class III cabinet can be compromised by puncture of the gloves, breakage of seals, or conditions that create positive pressure in the cabinet. Despite the apparent attractiveness of Class III cabinets, they have several inherent disadvantages including:

a. Very poor work accessibility;

b. They are large and therefore can not be readily moved with there contents to a safe area; and

c. They are expensive so they are not readiliy available to the general public for simple uses such as inspecting and opening mail.

Another device for use with potentially contaminated items is a glove bag such as sold by Instruments for Research for Industry, Inc. of Cheltenham, Pa. It is used like a rigid glove box but has the flexibility of a plastic bag. It is made of thick polyethylene, with integral gloves one or more sleeve for introduction of instruments or items and an inflation port. A deficiency of the glove bag is that it must be inflated during us to lift the bag off of the items within the bag for ease of manipulation of those items.

### BRIEF DESCRIPTION

A device including features of the present invention comprises a upright standing container or box with removable lid or side, the box having optically transparent portions for viewing the contents thereof and for transmission of light from a light source for illuminating the contents being inspected. The container also has right and left hand gloves integral therewith, the gloves extending into the interior of the box for manipulating its contents. The base of the container has a colored or black surface specifically provided for visualizing substances, such as a white powder which may have been contained in an envelope, such as a letter, or package placed in the container for inspection of its contents. The letter openers (electrical or blades) for opening items, magnifying optics for examining items placed in the container and particle detection means may also be incorporated in or placed in the container.

### BRIEF DESCRIPTION OF THE DRAWINGS

FIG. 1 is a front perspective view of a container including features of the invention.

FIG. 2 is a front perspective view of an alternative construction of a container including features of the invention.

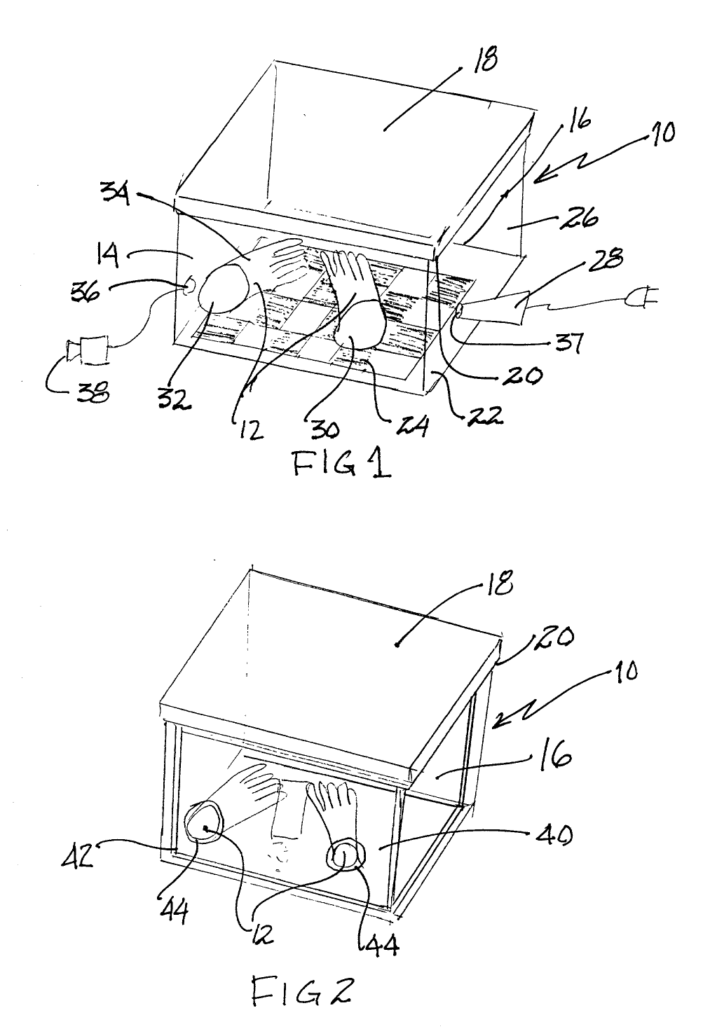

### DETAILED DESCRIPTION

A rigid container 10 has a pair of gloves 12 integral with a front wall 14 of the container 10, the gloves 12 extending into the interior 16 of the container. The embodiment shown has a lid 18 that is removable so that items to be examined can be placed in the box. The junction between the lid 18 and the box includes a seal 20, such as a gasket, interlocking tongue and groove or other similar sealing means, such that once closed, the contents of the box can not readily escape without removal of the lid 18. A seal design typically used with lids on plastic containers used to store foods is an example of a suitable closure and seal. However, one skilled in the art can readily provide other suitable seal structures which are, in any event, within the scope of the invention.

In contrast with prior available devices, the container 10 does not have vents or any means for delivering flowing air. This is an important safety feature because powdered contaminants, such as dried, finely milled, powdered, freeze dried or miceoencapsulated anthrax, when present as micron sized particles, may be readily carried by moving air streams and may bypass general use filter systems. Also there is no need for inflation of the container 10. The floor 22 of the container is colored, or has means for insertion of a colored sheet 24, so that any powdered substance which falls from the item being opened can be readily seen. In one embodiment the floor 22 of the container is black so that white powder can be readily observed. In a second embodiment the floor 22 is provided with a checker board or other geometric pattern of black and white squares so that both a white powder or a brown or other colored powders can de readily seen.

The preferred container is constructed from rigid plastic materials so that it has the appearance of a plastic box. However, it is also contemplated that the walls may be formed of a flexible but impervious plastic material 40 and that the container rendered substantially rigid by expanding a rigid frame 42 within or external to the box shaped enclosure.

The front or side walls of the container have right and left gloves 30, 32, with arm extensions 34 integral therewith and extending into the box so that an individual, after placing envelopes or packages in the container can place hands and arms in the gloves to manipulate the contents of the container. The gloves 30, 32 and glove arms 34 are constructed of a flexible plastic or rubber material that is impermeable to biological or chemical toxins which may be contained in the objects being opened and inspected. Also the top of the arm portions 34 on the gloves, as well as the seal 20 when the lid 18 is attached to the container, must be sealed to the container walls so that any powder, aerosol or vapor released from the contents of items placed in the container cannot escape from the container. The gloves 30, 32 or arm extensions 34 may be permanently attached to the fron wall 14 of the container 10 or secured by a suitable mounting flange 44 so that they can be periodically replaced.

The container 10 can be constructed of a transparent material so that its contents can be readily observed, or have transparent windows for visualization and light transmission. In a preferred embodiment at least one side wall 26 is transparent for light transmission. A light fixture or laser 28 is mounted external to the transparent side wall 26 so that the light illuminates items being opened and any materials falling out of the items once opened.

In some instances the ability to adequately observe the presence of powdery substances falling from the opened envelope or package is difficult to observe. Therefore electronic or optical devices may be provided to aid in detecting the presence. The light may be incandescent, fluorescent, halogen light or similar light source. Alternatively, the light source may be monochromatic or be limited in wave length to that which may be most beneficial for observing particular prior identified contaminants which are being searched for. Also the light source may provide UV or IR light, or have an adjustable wave length, if desired. In one embodiment the light source may be transmitted through a collimating lens 37 or one or more laser beams so as to shine on a photosensor 36 mounted on or in the opposite wall so that a substance, such as a powder, falling through the light beam will cause the light beam to be momentarily interrupted, causing the photosensor to sound an alarm 38. In an alternative embodiment other photosensors may be located around the periphery of the box, but not in the path of the light beam, so that light reflected off of falling powder strikes other photosensors tripping an alarm.

Another alternative is to provide a sensitive electronic scale on the bottom of the container so that any particulate matter (powder) dropping from the opened item can be detected by a change in weight of the top surface of the scale.

To assist in opening packages a letter or package opener incorporating a razor blade or and electric envelope cutter may be placed in the box for use in opening the items. To aid in observation of contents optical magnifying instruments may also be included or the front wall or lid may include magnifying optics. The container may also include trays or sorting compartments for organizing opened or unopened items and other packaging materials for bundling opened, non-contaminated items for later distribution.

The container 10 incorporating features of the invention also has utility solely for inspection of envelopes and packages before opening. Individuals receiving mail are instructed to consider as suspicious any mail that is:

a) Unexpected or is from an unfamiliar source,

b) Addressed to someone no longer with your organization or is outdated in any way.

c) Has no return address or an address that cannot be verified,

d) Is lopsided, oddly shaped, or has an unusual weight, given its size,

e) Is marked with restrictive endorsements, such as “Personal” or “Confidential”,

f) Has protruding wires, strange odors or stains, or

g) Shows a city or state in the postmark that doesn't match the return address.

In such an instance, sealable plastic bags, such as Zip Lock® bags, may be placed within the container 10 for isolating such suspicious envelopes or packages before opening by proper authorities.

A particular advantage of the container incorporating features of the invention is that, should a contaminant be suspected or identified in an envelope or package opened therein, the items and contaminants do not have to be removed from the container for transport to a secured facility for examination. The container is so light and portable, and has no electrical connections or connections to blowers, filters or inflation means so it can be lifted and transported, with its contents to a safe location for further examination of its contents and decontamination or proper destruction if appropriate.

It is evident from the foregoing that there are many additional embodiments of the present invention that, while not expressly described herein, are within the scope of this invention and may suggest themselves to one of ordinary skill in the art. Other variations include a box or bag with only one glove and a blade or an electric letter opener for opening envelopes mounted in the box. It is therefore intended that the invention be limited solely by the appended claims.

I claim:

1. A device for use in safely examining items that may contain powdered contaminants comprising:
a container having a horizontal base, four walls vertical to said base and a lid attached horizontally to said four side walls, said base, walls and lid forming a non-permeable enclosure for items, the lid being removable and replaceable for placement of items in the container, such that when the lid is reattached to the four side walls, any items placed in the container, and any contents of said items are sealed within the container until the lid is once more removed,
at least one wall of the container having flexible gloves impermeable to biological contaminants attached thereto and extending into the interior of the container,
at least a portion of the walls or lid being transparent so that items placed therein, and their contents when opened can be readily observed, and light from sources mounted external to the container can readily penetrate the container wall and illuminate the items and, once the items are opened, their contents,
the container having detection means incorporated therewith for observing foreign substances released from items opened within the container.

2. The device of claim 1 wherein the detection means comprises a colored container bottom surface.

3. The device of claim 1 wherein the detection means comprises a black container bottom surface.

4. The device of claim 1 wherein the detection means comprises a geometric pattern on the bottom surface comprising black and white areas.

5. The device of claims 4 wherein the geometric pattern is a checker board pattern.

6. The device of claim 1 wherein the detection means comprises a collimated light beam transmitted from a position external of one wall and a photodetector located at an opposite wall in the path of the collimated light beam, the photodetector sensitive to the interruption of the collimated light beam by particles falling through said light beam, such interruption activating an alarm.

7. The device of claim 1 wherein the detection means comprises a collimated light beam transmitted from a position at of one wall and a photodetector located at a position not in the path of the collimated light beam, the photodector sensitive to reflected light impinging thereon as a result of the interruption of the collimated light beam by particles falling through said light beam, such detection of reflected light activating an alarm.

8. The device of claim 1 wherein the detection means comprises one or more laser beams generated by a source external of one wall and a photodetector located at an opposite wall in the path of one or more of the laser beams, the photodetector being sensitive to the interruption of the one or more laser beams by particles falling through said laser beams, such interruption activating an alarm.

9. The device of claim 1 wherein the detection means comprises and electronic scale placed on the container horizontal bottom, the scale capable of detecting a weight increase due to powdered material landing thereon, such weight increase activating an alarm.

10. The device of claim 1 wherein the gloves are removeable and replaceable, the replaceable gloves being secured to the front wall by a leak proof mounting flange.

11. The device of claim 1 for use in detecting the presence of dry, powdered anthrax released from an envelope or package during opening thereof.

12. The device of claim 6 wherein the source of the light beam is external of the wall.

13. The device of claim 7 wherein the source of the light beam is external of the wall.

14. The device of claim 8 wherein the source of the laser beam is external of the wall.
